(19) United States
(12) Patent Application Publication
(10) Pub. No.: US 2016/0199247 A1
(43) Pub. Date: Jul. 14, 2016

(54) Transparent Tray for a Walker

(71) Applicants: Megan McCuen, Cincinnati, OH (US); Mimi Leverone, Cincinnati, OH (US); Penny Davidson, Cincinnati, OH (US)

(72) Inventors: Megan McCuen, Cincinnati, OH (US); Mimi Leverone, Cincinnati, OH (US); Penny Davidson, Cincinnati, OH (US)

(21) Appl. No.: 14/595,126

(22) Filed: Jan. 12, 2015

(51) Int. Cl. A61H 3/04; A47B 13/16; A47B 23/00; A47B 13/12

(52) U.S. Cl. CPC A61H 3/04; A47B 13/12; A47B 13/16; A47B 23/001; A61H 2003/004

(57) ABSTRACT

Described herein is a transparent tray that is attachable to and removable from the handrails of a walker for the physically infirm. The improvement comprises the transparency of the tray.

### FIELD OF THE INVENTION

The invention described herein relates generally to walkers, and specifically to walkers typically used by the elderly and physically infirm. In particular, the feature described and claimed in this disclosure is a transparent tray. The tray removably attaches to the walker and facilitates use of, the walker by allowing the user to see his feet and the immediate path ahead.

### DESCRIPTION OF THE PRIOR ART

The prior patent art with regard to walkers for the elderly and physically infirm is extensive and searchably responsive to the simplest of key word inquiries. Every aspect and feature of walkers with trays is ostensibly disclosed and described in the prevailing patent art. Most of the patents describe features, methods and means for attaching, removing or utilizing a tray in association with the commonly used four-legged walker. None, however, addresses the ease of use and enhanced safety features resulting from the attachment of a transparent tray to walker

### SUMMARY OF THE INVENTION

Notwithstanding the disclosures of the prior art, there remains a need for an improved four-legged walker for the infirm that is easier and safer to use than walkers described and used heretofore. Specifically, the walker described herein is for the ambulatory support of the infirm and features a walker having a pair of handrails and a tray that is removably attachable to the handrails and wherein the improvement comprises the transparency of the tray.

### BRIEF DESCRIPTION OF THE DRAWING

FIG. 1 is a perspective view of the transparent tray for a walker as described herein.

FIG. 2 is a top plan view of the transparent tray.

### DETAILED DESCRIPTION OF THE PREFERRED EMBODIMENT

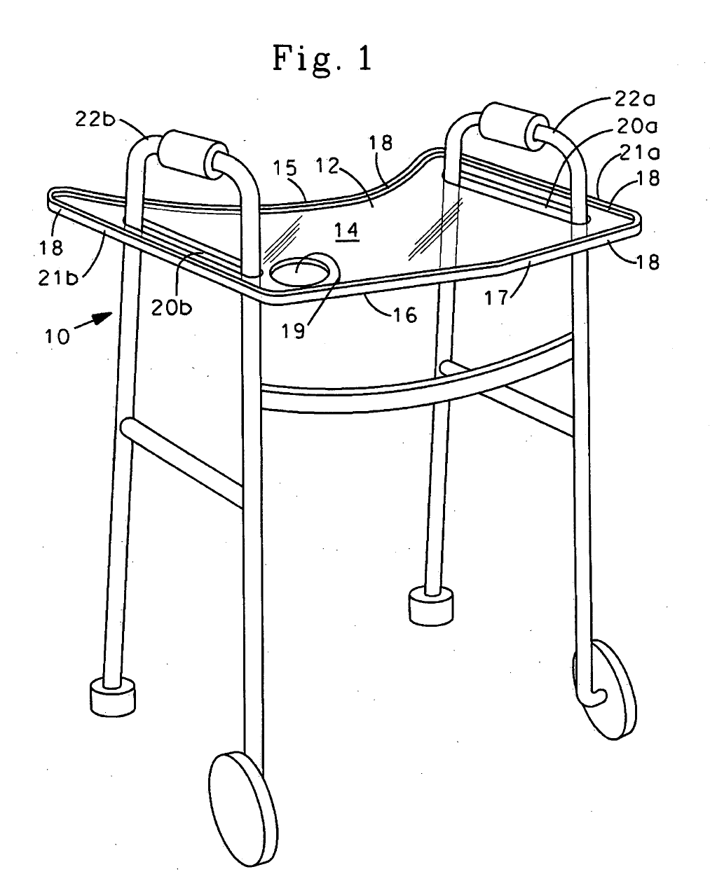

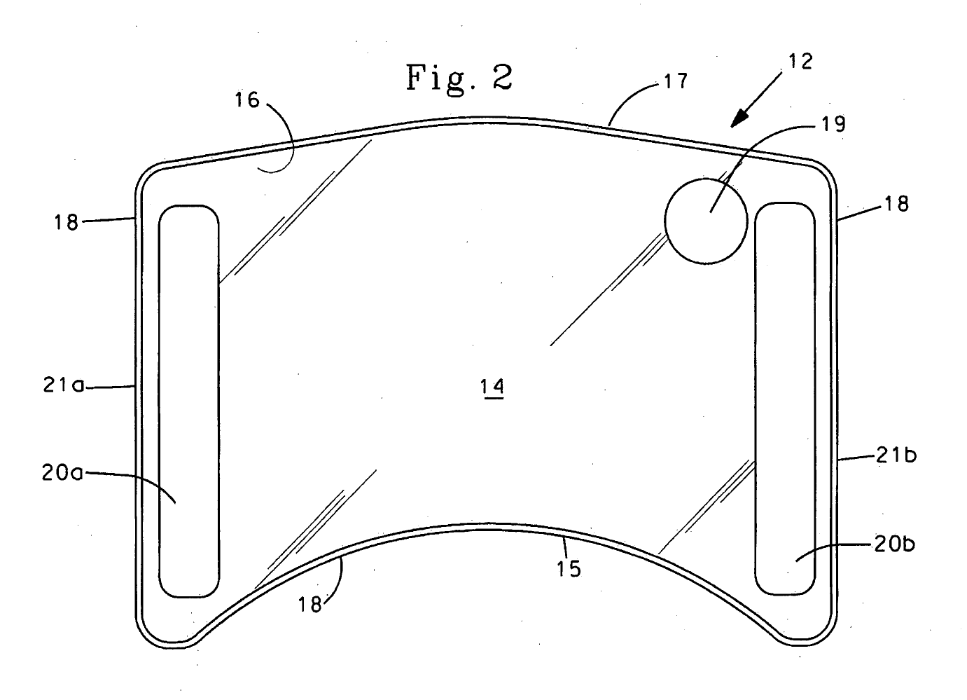

With specific-regard to the disclosed transparent tray for a walker, reference should be made to FIGS. 1 and 2 of the drawing. FIG. 1 is a perspective depiction of a walker fitted with a transparent tray 10. The walker can be any of a variety of commercially available walkers. The only structural requirement necessary for the walker and its user to benefit from the disclosed transparent tray 12 is that it be equipped with a pair of handrails 22a and 22b.

The transparent tray 12 is a generally rigid plastic tray molded from polymers formulated to produce a transparent tray, which allows the user of a walker so equipped to observe his feet and the path ahead. The transparent tray is typically four-sided with top 14 and bottom 16 surfaces. The perimeter of the top surface is preferably defined by a ridge 18, which assists in confining certain and sundry items to the top surface 14 of the tray 12.

Currently, the transparent tray 12 is vacuum formed using a polycarbonate thermoplastic such as Lexan®. Other plastics, such as acrylics, may also be used to form the transparent tray 12, and materials and methods ultimately used will be dictated by costs and properties.

Laterally positioned and extending through the surfaces 14, 16 of the tray 12 are a pair of elongated slots 20a and 20b. These slots are positioned to accommodate the insertion of the handrails of the walker, as depicted in FIG. 1. The tray is thus attachable to and removable from the walker. The ability to easily attach and remove the tray 12 facilitates folding the walker for ease of transport and storage.

Optionally, the tray 12 can be molded to incorporate a variety of other features such as the opening 19, which is intended to accommodate the insertion of a cup or similar container.

Currently, the tray 12 is preferably molded and shaped to have a concave edge 15 to allow the user to bring the walker closer to the body for greater stability and control. For aesthetics and ease of forming, the tray 12 currently features a convex edge 17, diametrically opposite the concave edge and having generally parallel edges 21a and 21b.

While the foregoing is a detailed and complete description of the preferred embodiment of the disclosed transparent tray for a walker, it should be apparent that numerous variations and modifications can be made to the disclosed tray and utilized to implement the overall purpose of the tray without deviating or departing from spirit of the invention, which, is fairly defined by the appended claims.

1. A walker for the ambulatory support of the physically infirm having a pair of hand rails and a tray removably attachable to said hand rails wherein the improvement comprises the transparency of said tray allowing the user of said walker to observe his/her feet and a path ahead.

2. The walker according to claim 1 wherein the transparent tray has a pair of laterally positioned slots receptive to the insertion of said handrails.

3. The walker according to claim 1 wherein the transparent tray has a generally rigid and rectangular shape and has top and bottom surfaces.

4. The walker according to claim 3 wherein the top surface of the transparent tray has an elevated perimeter creating a recessed top surface.

5. The walker according to claim 4 wherein said perimeter of the transparent tray has two parallel sides.

6. The walker according to claim 4 wherein said perimeter of the transparent tray has a concave side.

7. The walker according to claim 4 wherein said perimeter of the transparent tray has a convex side.

8. The walker according to claim 3 wherein the transparent tray has an opening through said top and bottom surfaces receptive to the placement of a container.
